(19) United States
(12) Patent Application Publication
(10) Pub. No.: US 2026/0319497 A1
(43) Pub. Date: Oct. 15, 2026

(54) APPARATUS AND METHOD FOR TOPOLOGY-BASED SEMANTIC MAP GENERATION

(71) Applicants: Hyundai Motor Company, Seoul (KR); Kia Corporation, Seoul (KR)

(72) Inventor: Changyo Lee, Hwaseong-si (KR)

(21) Appl. No.: 19/338,598

(22) Filed: Sep. 24, 2025

(30) Foreign Application Priority Data
Apr. 14, 2025 (KR) 10-2025-0047863

(51) Int. Cl. G05D 1/246; G05D 101/15; G05D 105/80; G05D 109/10; G05D 111/10; G05D 111/50

(52) U.S. Cl. CPC G05D 1/2467; G05D 1/2464; G05D 1/2469; G05D 2101/15; G05D 2105/87; G05D 2109/10; G05D 2111/17; G05D 2111/52

(57) ABSTRACT

In an embodiment a method for topology-based semantic map generation includes mapping, by a processor, an environment through a sensor of a robot to generate an initial map;, generating, by the processor, a topology space through data pre-processing based at least in part on the initial map, generating, by the processor, a topology node based at least in part on the topology space, generating, by the processor, a topology edge with respect to the topology node, assigning, by the processor, semantic spatial information with respect to the topology space based at least in part on the topology node and the topology edge, and generating, by the processor, the semantic map.

### CROSS-REFERENCE TO RELATED APPLICATIONS

This application claims the benefit of and priority to Korean Patent Application No. 10-2025-0047863 filed with the Korean Intellectual Property Office on Apr. 14, 2025, the entire contents of which is incorporated herein by reference.

### TECHNICAL FIELD

The present disclosure relates to an apparatus and method corresponding to at least topology-based semantic map generation, and more particularly, the present disclosure relates to an apparatus and method corresponding to at least topology-based semantic map generation, corresponding to at least generating a service environment space definition-based semantic map in a mobile robot in an embedded environment.

### BACKGROUND

Mobile robots often need to adopt different driving strategies depending on whether they are indoors or outdoors or in specific areas. Accordingly, research is being conducted on efficient and safe driving strategies by distinguishing information about the robot's driving area using computer vision technology and deep learning.

Research is currently being conducted in two major ways. Computer vision methods extract shape information (triangles, squares, circles) from a given raw 2D image map to distinguish between spaces.

As a deep learning method, research is being conducted on projecting object information onto floor plans, which is obtained by model learning through a large amount of learning data, such as, or a 2D map by distinguishing areas through semantic information from image sensors.

Conventional technologies are fundamentally difficult to separate space in non-linear environments (offices and non-linear structural layouts), require a lot of learning data and time, and require devices capable of high computation for modeling. In addition to time and cost issues, there is the problem that it is difficult for low-specification embedded system-based robots to accurately distinguish spaces and that it is difficult to distinguish spaces by inferring models.

### SUMMARY

Disclosed embodiments relate to topology-based semantic map generation configured to generate a semantic map in which steppable regions and non-steppable regions are distinguished according to a driving strategy of a mobile robot based at least in part on topology in a low-specification embedded environment.

Topology-based semantic map generation, which may be performed by one or more computing device(s), processor(s) and memory(ies), may include mapping an environment through a sensor of a robot to generate an initial map, generating a topology space through data pre-processing based at least in part on the initial map, generating a topology node based at least in part on the topology space, generating a topology edge with respect to the topology node, and assigning a semantic spatial information with respect to the topology space based at least in part on the topology node and the topology edge, and generating the semantic map.

The mapping the environment through the sensor of the robot to generate the initial map may include collecting data of the environment through a lidar and an IMU sensor, by the processor, estimating a position of the robot based at least in part on the collected data, by the processor, generating a 3D map through a 3D point cloud, by the processor, and Converting the 3D map into a 2D occupancy grid map, by the processor.

The generating the topology space through data pre-processing based at least in part on the initial map may include converting the 2D occupancy grid map into a binarized map by processing binarization, by the processor, generating a distance conversion map through distance conversion based at least in part on the binarized map, by the processor, and generating the topology space by normalizing the distance conversion map, by the processor.

The generating the topology node based at least in part on the topology space may include setting a size of a grid pixel by reflecting a size of the robot, by the processor, and setting an interval between nodes based at least in part on the size of the grid pixel, by the processor.

The generating the topology edge with respect to the topology node may include searching a distance between nodes based at least in part on the interval between nodes and generating edges connecting adjacent nodes of which the distance falls within a preset minimum distance, by the processor.

The searching the distance between nodes based at least in part on the interval between nodes and generating edges connecting adjacent nodes of which the distance falls within the preset minimum distance may include searching the distance between nodes by using a KD Tree, by the processor, connecting adjacent nodes based at least in part on the minimum distance and generate edge information, by the processor, checking whether there is an obstacle between edges based at least in part on the edge information and then deleting one or more edges where there exists an obstacle, by the processor, and checking whether the generated edge information overlaps with already stored edge information, and updating the edge information, by the processor.

The assigning the semantic spatial information with respect to the topology space based at least in part on the topology node and the topology edge and generating the semantic map may include grouping the topology space by using the topology node and the topology edge, by the processor, semantically distinguishing the topology space, by the processor, and assigning an ID to the distinguished topology space, by the processor.

The grouping the topology space by using the topology node and the topology edge may include initializing, corresponding to at least setting all nodes as an independent group through a Union-Find algorithm, by the processor, and determining nodes connected to each other as a same group by using the edge, by the processor.

The generating the topology space through data pre-processing based at least in part on the initial map may include dividing the topology space into an open space where the robot can move and a closed space where the robot cannot move, by the processor.

The dividing the topology space into the open space where the robot can move and the closed space where the robot cannot move may include generating the open space through pre-processing in the initial map, by the processor, and defining the open space as a region-of-interest (ROI), and determining a region out of the ROI as the closed space, by the processor.

An apparatus corresponding to at least topology-based semantic map generation, corresponding to at least generating a semantic map in a mobile robot in an embedded environment based at least in part on topology by executing program code loaded on one or more memory devices through one or more processors, where the program code may include, when executed, mapping the environment through a sensor of the robot to generate an initial map, generating a topology space through data pre-processing based at least in part on the initial map, generating a topology node based at least in part on the topology space, generating a topology edge with respect to the topology node, assigning a semantic spatial information with respect to the topology space based at least in part on the topology node and the topology edge and generating the semantic map.

The mapping the environment through the sensor of the robot to generate the initial map may include collecting data of the environment through a lidar and an IMU sensor, estimating a position of the robot based at least in part on the collected data, generating a 3D map through a 3D point cloud, and converting the 3D map into a 2D occupancy grid map.

The generating the topology space through data pre-processing based at least in part on the initial map include converting the 2D occupancy grid map into a binarized map by processing binarization, generating a distance conversion map through distance conversion based at least in part on the binarized map, and generating the topology space by normalizing the distance conversion map.

The generating the topology node based at least in part on the topology space may include setting a size of a grid pixel by reflecting a size of the robot, and setting an interval between nodes based at least in part on the size of the grid pixel.

The generating the topology edge with respect to the topology node may include searching a distance between nodes based at least in part on the interval between nodes and generating edges connecting adjacent nodes of which the distance falls within a preset minimum distance.

The searching the distance between nodes based at least in part on the interval between nodes and generating edges connecting adjacent nodes of which the distance falls within the preset minimum distance may include searching the distance between nodes by using a KD Tree, connecting adjacent nodes based at least in part on the minimum distance and generate edge information, checking whether there is an obstacle between edges based at least in part on the edge information and then deleting one or more edges where there exists an obstacle, and checking whether the generated edge information overlaps with already stored edge information and updating the edge information.

The assigning the semantic spatial information with respect to the topology space based at least in part on the topology node and the topology edge and generating the semantic map may include grouping the topology space by using the topology node and the topology edge, semantically distinguishing the topology space, assigning an ID to the distinguished topology space.

The grouping the topology space by using the topology node and the topology edge may include initializing, corresponding to at least setting all nodes as an independent group through a Union-Find algorithm, and determining nodes connected to each other as a same group by using the edge.

The generating the topology space through data pre-processing based at least in part on the initial map may include dividing the topology space into an open space where the robot can move and a closed space where the robot cannot move.

The divide the topology space into the open space where the robot can move and the closed space where the robot cannot move may include generating the open space through pre-processing in the initial map, and defining the open space as a region-of-interest (ROI), and determining a region out of the ROI as the closed space.

An apparatus and method corresponding to at least topology-based semantic map generation according to an embodiment can efficiently generate a semantic map in a low-specification embedded environment based at least in part on topology, to separately distinguish a non-linear space, does not require the construction of a dataset, and can quickly adapt to a service without an expensive computational device.

An apparatus and method corresponding to at least topology-based semantic map generation according to an embodiment can obtain a map in which spatial areas are separated in various indoor environments with clear structures obtain, and may visualize spatial information including spaces where robot can and cannot go.

### BRIEF DESCRIPTION OF THE DRAWINGS

FIG. 1 to FIG. 8 are flowcharts of a method corresponding to at least topology-based semantic map generation according to an embodiment.

FIG. 9 is a block diagram of an apparatus corresponding to at least topology-based semantic map generation according to an embodiment.

FIG. 10 is an example diagram corresponding to at least explaining topology-based semantic map generation according to an embodiment.

FIG. 11 is a drawing corresponding to at least explaining a computing device according to an embodiment.

### DETAILED DESCRIPTION OF ILLUSTRATIVE EMBODIMENTS

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

Additionally, at least some of the configurations or functions of an apparatus and method corresponding to at least topology-based semantic map generation according to the embodiments described below may be implemented as a program or software, and the program or software may be stored in a computer-readable medium.

Hereinafter, embodiments of the present disclosure will be described with reference to the drawings.

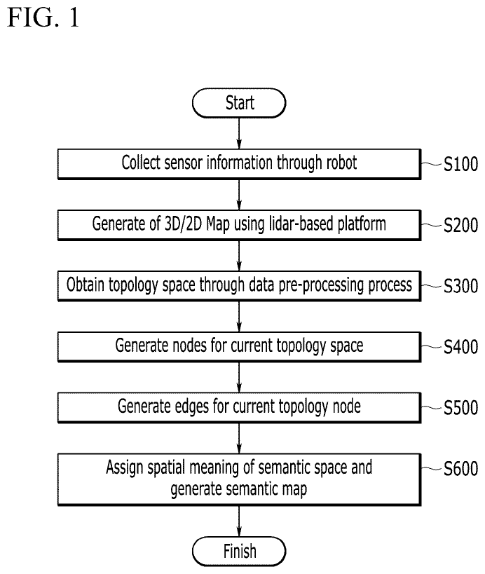

FIG. 1 to FIG. 8 are flowcharts of a method corresponding to at least topology-based semantic map generation according to an embodiment.

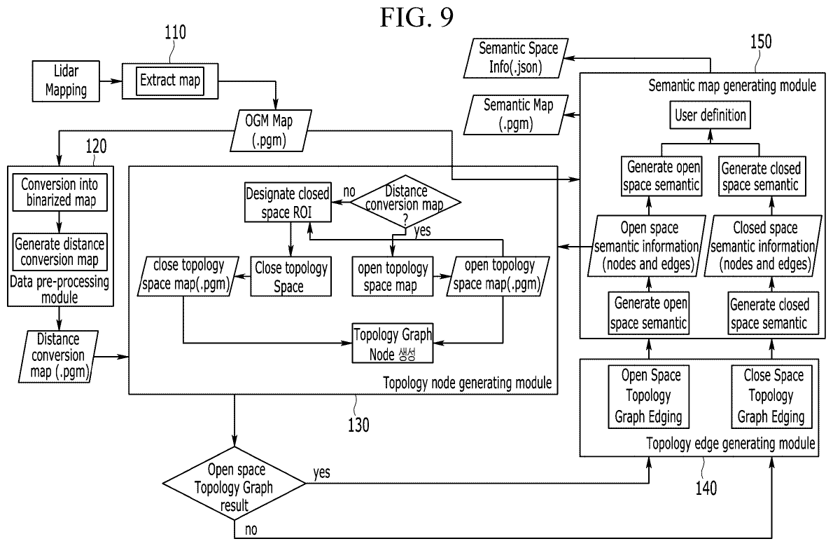

A method corresponding to at least topology-based semantic map generation according to an embodiment of FIG. 1 to FIG. 8 may be performed through an apparatus 100 corresponding to at least topology-based semantic map generation (see FIG. 9).

The apparatus 100 corresponding to at least topology-based semantic map generation according to the embodiment may execute a program code or instruction stored in one or more memory devices through one or more processors.

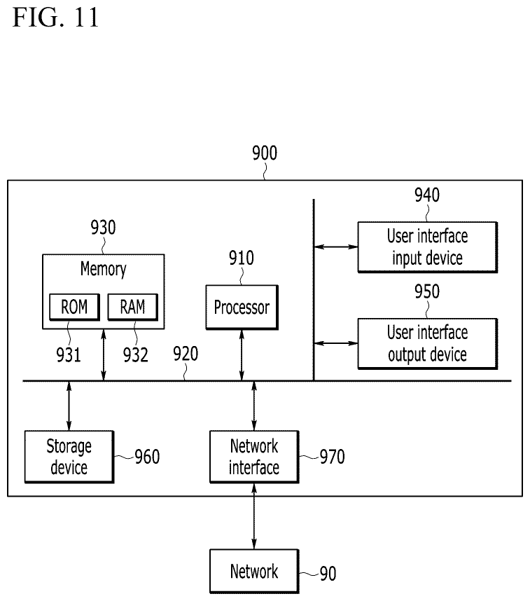

For example, the apparatus 100 corresponding to at least topology-based semantic map generation may be implemented as a computing device 900 described later with reference to FIG. 11. In this case, the one or more processors may correspond to a processor 910 of the computing device 900, and the one or more memory devices may correspond to a memory 930 of the computing device 900.

The program codes or instructions may be executed by the one or more processors, to generate a semantic map in a mobile robot in an embedded environment based at least in part on topology.

FIG. 1 is a flowchart corresponding to at least explaining a method corresponding to at least topology-based semantic map generation according to an embodiment.

In FIG. 1, the apparatus 100 corresponding to at least topology-based semantic map generation may collect sensor information from sensors of the robot, at step S100.

For example, the sensors of the robot may include a LiDAR sensor, an RGB-D sensor, and an IMU sensor.

The apparatus 100 corresponding to at least topology-based semantic map generation may generate 3D and/or 2D map by using a lidar-based platform, at step S200.

The apparatus 100 corresponding to at least topology-based semantic map generation may obtain a topology space through a data pre-processing process, at step S300.

For example, the apparatus 100 corresponding to at least topology-based semantic map generation may obtain each of an open space where the robot is movable and a closed space where the robot is not movable as the topology space.

That is, the topology space may include both the open space and the closed space.

The apparatus 100 corresponding to at least topology-based semantic map generation may first obtain the open space and then sequentially obtain the closed space based at least in part on the open space.

The apparatus 100 corresponding to at least topology-based semantic map generation may generate nodes with respect to a current topology space, at step S400.

The apparatus 100 corresponding to at least topology-based semantic map generation may generate nodes in consideration of the size of the robot, by using the generated topology space map.

The apparatus 100 corresponding to at least topology-based semantic map generation may generate an edge with respect to a current topology node, at step S500.

The apparatus 100 corresponding to at least topology-based semantic map generation may assign a spatial meaning of the semantic space and generate the semantic map, at step S600.

The apparatus 100 corresponding to at least topology-based semantic map generation may provide a unique ID to the topology space by using the obtained Topology graph information (node and edge).

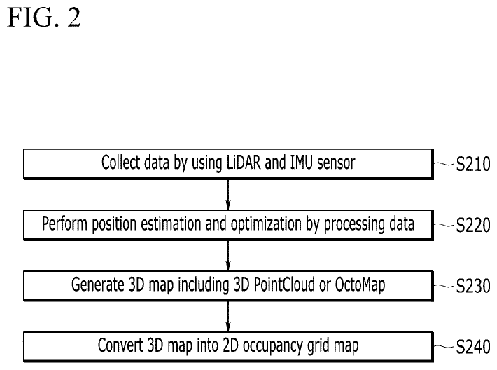

FIG. 2 is a flowchart corresponding to at least explaining 3D/2D Map generation step (the step S200) using the lidar-based platform of FIG. 1.

In FIG. 2, the apparatus 100 corresponding to at least topology-based semantic map generation may collect data by using the LiDAR and the IMU sensor, at step S210.

The apparatus 100 corresponding to at least topology-based semantic map generation may collect data of an adjacent environment by using the LiDAR and the IMU sensor of a robot or a handheld device.

The apparatus 100 corresponding to at least topology-based semantic map generation may perform position estimation and optimization by processing data, at step S220.

That is, the apparatus 100 corresponding to at least topology-based semantic map generation may extract features of LiDAR data from simultaneous localization and mapping (SLAM) Front-End, and may estimate a position of the robot.

The apparatus 100 corresponding to at least topology-based semantic map generation may perform optimization by utilizing IMU data in the SLAM Back-End.

The apparatus 100 corresponding to at least topology-based semantic map generation may generate a 3D map, and may generate 3D PointCloud or OctoMap, at step S230.

The apparatus 100 corresponding to at least topology-based semantic map generation may convert 3D data into a 2D occupancy grid map (e.g., PGM format), at step S240.

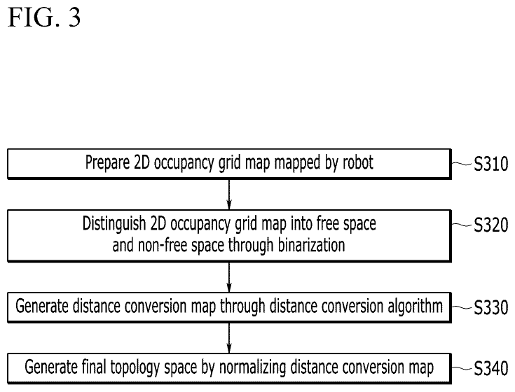

FIG. 3 is a flowchart corresponding to at least explaining the topology space obtain step (the step S300) through the data pre-processing process of FIG. 1.

In FIG. 3, the apparatus 100 corresponding to at least topology-based semantic map generation may prepare the 2D occupancy grid map mapped by the robot, at step S310.

The apparatus 100 corresponding to at least topology-based semantic map generation may generate a binarized map that distinguishes a free space (the open space) and a non-free space (the closed space) by processing binarization on the 2D occupancy grid map, at step S320.

The apparatus 100 corresponding to at least topology-based semantic map generation may generate a distance conversion map through a distance conversion algorithm based at least in part on the binarized map, at step S330.

At this time, the apparatus 100 corresponding to at least topology-based semantic map generation may generate the distance conversion map generate by calculating a shortest distance from a black color pixel closest to a white color pixel within a 5×5 region (kernel) around a pixel.

The apparatus 100 corresponding to at least topology-based semantic map generation may generate the final topology space by normalizing the distance conversion map, at step S340.

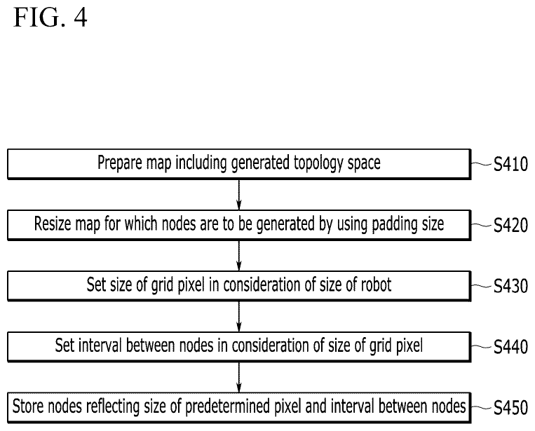

FIG. 4 is a flowchart corresponding to at least explaining the node generation step (the step S400) with respect to the current topology space of FIG. 1.

The apparatus 100 corresponding to at least topology-based semantic map generation may generate nodes based at least in part on the input of the binarized map, robot size, resolution size by using the function of Particle Uniformly Generate On Free Space.

In FIG. 4, the apparatus 100 corresponding to at least topology-based semantic map generation may prepare the topology space map including the generated topology space, at step S410.

The apparatus 100 corresponding to at least topology-based semantic map generation may resize the map corresponding to at least which nodes are to be generated by using a padding size, at step S420.

The apparatus 100 corresponding to at least topology-based semantic map generation may remove a noise portion through edge trimming of a map image.

The apparatus 100 corresponding to at least topology-based semantic map generation may set a size of a grid pixel in consideration of the size of the robot, at step S430.

For example, when the resolution is 0.05 of the actual scale, if the size of the robot is 1 m, the robot size in the grid map may be 50. Note references to scales and relative sizes are not necessarily precise measurements, and may, for example, encompass minor variation and approximation that meets the indicated intended relative relationship.

A grid size may determine the nodes are to be generated at the interval of how many grids. For example, when the grid size is 10, the nodes may be generated with an interval of 0.2 m. The padding may mean extracting a meaningful region from a map image.

For example, the apparatus 100 corresponding to at least topology-based semantic map generation may retrieve a pixel coordinate system as large as the grid size, and when the value of corresponding pixel is 255, consider it as a primarily topology space.

The apparatus 100 corresponding to at least topology-based semantic map generation may set an interval between nodes in consideration of the size of the grid pixel, at step S440.

The apparatus 100 corresponding to at least topology-based semantic map generation may secondarily determine whether the pixel coordinate that was primarily considered as the topology space is a topology space where the robot can actually path through by using radius distance in consideration of the size of the robot based at least in part on the interval between nodes (the step S440).

The apparatus 100 corresponding to at least topology-based semantic map generation may store nodes reflecting a size of a predetermined pixel and the interval between nodes, at step S450.

The apparatus 100 corresponding to at least topology-based semantic map generation may store points satisfying both the primary and secondary determination as nodes.

The apparatus 100 corresponding to at least topology-based semantic map generation may generate nodes corresponding to at least each robot grid pixel size (e.g., 5 pixels).

When pixel information around a robot size node indicates black color (0), the apparatus 100 corresponding to at least topology-based semantic map generation may delete the grid pixel from the node candidate group.

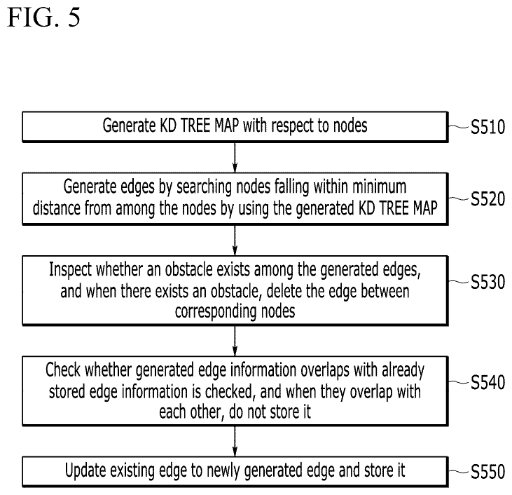

FIG. 5 is a flowchart corresponding to at least explaining the edge generation step (the step S500) with respect to the current topology node of FIG. 1.

The apparatus 100 corresponding to at least topology-based semantic map generation may search a distance between nodes based at least in part on the interval between nodes, and may generate an edge connecting adjacent nodes of which the shortest distance falls within a preset minimum distance.

In FIG. 5, the apparatus 100 corresponding to at least topology-based semantic map generation may generate a KD TREE MAP with respect to the stored nodes, at step S510.

The KD TREE MAP is a data structure-based map that enables efficient storing and searching of point data on the space, which may be a tree structure created to enable fast searches by dividing a k-dimensional (2D, 3D, or the like) space.

The apparatus 100 corresponding to at least topology-based semantic map generation may generate edges by searching nodes falling within a minimum distance from among the nodes by using the generated KDTREE MAP, at step S520.

That is, the apparatus 100 corresponding to at least topology-based semantic map generation may perform a pair work between nodes through the preset minimum distance (e.g., 50 pixels) through Nearest Search.

The apparatus 100 corresponding to at least topology-based semantic map generation may inspect whether an obstacle exists among the generated edges, and when there exists an obstacle, may delete the edge between the corresponding nodes, at step S530.

The apparatus 100 corresponding to at least topology-based semantic map generation may check whether the generated edge information overlaps with already stored edge information, and when they overlap with each other, may not store it, at step S540.

The apparatus 100 corresponding to at least topology-based semantic map generation may update the existing edge to the newly generated edge and store it, at step S550.

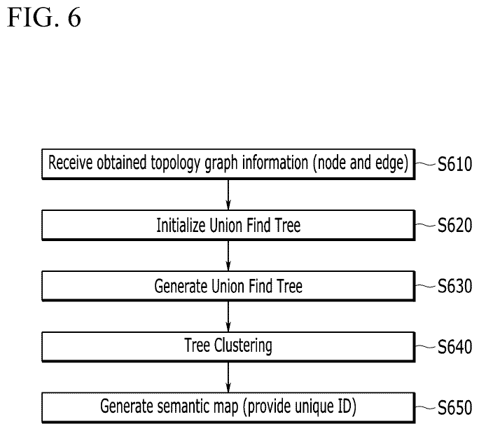

FIG. 6 is a flowchart corresponding to at least explaining spatial meaning assigning and semantic map generation step (the step S600) of the semantic space of FIG. 1.

In FIG. 6, the apparatus 100 corresponding to at least topology-based semantic map generation may receive the obtained topology graph information (node and edge), at step S610.

The apparatus 100 corresponding to at least topology-based semantic map generation may initialize Union-Find Tree based at least in part on the stored node information, at step S620.

The Union-Find Tree may be a data structure that efficiently handles the management of multiple sets.

The apparatus 100 corresponding to at least topology-based semantic map generation may generate Union Find Tree based at least in part on the stored edge information and initialization information, at step S630.

The apparatus 100 corresponding to at least topology-based semantic map generation may perform Tree Clustering (grouping) that groups nodes into clusters by using a Union-Find data structure, at step S640.

For example, the apparatus 100 corresponding to at least topology-based semantic map generation groups each pair in the edge list into the same set.

The apparatus 100 corresponding to at least topology-based semantic map generation may find a representative root to which each point (node) belongs and form a cluster based at least in part on this.

The apparatus 100 corresponding to at least topology-based semantic map generation may group the topology space by using the generated topology node and a topology edge.

That is, the apparatus 100 corresponding to at least topology-based semantic map generation may perform initialization corresponding to at least setting all nodes as an independent group through a Union-Find algorithm, and may determine nodes connected to each other as a same group by using the edge.

The apparatus 100 corresponding to at least topology-based semantic map generation may semantically distinguish the grouped topology space into semantic spaces, assign unique ID, and generate the semantic map, at step S650.

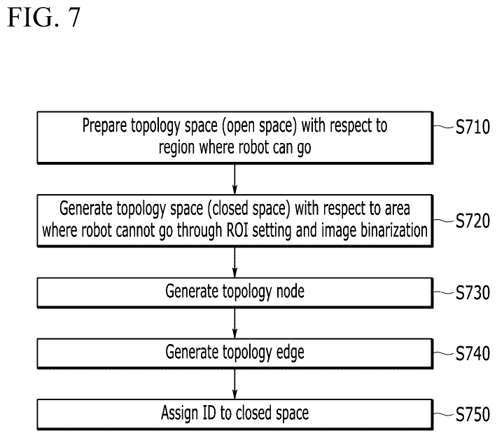

FIG. 7 is a flowchart corresponding to at least explaining a method corresponding to at least topology-based semantic map generation according to an embodiment.

FIG. 7 is a flowchart corresponding to at least explaining the step of dividing divide the topology space into the open space where the robot can move and the closed space where the robot cannot move when generating the topology space.

FIG. 7 is a flowchart corresponding to at least explaining the step of first generating a semantic map with respect to the open space and then generating the semantic map with respect to the closed space.

In FIG. 7, the apparatus 100 corresponding to at least topology-based semantic map generation may first prepare the generated topology space (the open space) with respect to the region where the robot can go, at step S710.

The apparatus 100 corresponding to at least topology-based semantic map generation may generate the topology space (the closed space) with respect to the region where the robot cannot go through ROI setting and image binarization, at step S720.

That is, the apparatus 100 corresponding to at least topology-based semantic map generation may define a predetermined open space as the ROI, and may determine a region out of the ROI as the closed space.

The apparatus 100 corresponding to at least topology-based semantic map generation may generate the topology node with respect to the determined closed space, at step S730. The topology node generation method with respect to the closed space may be referred to what was described with reference to FIG. 4.

The apparatus 100 corresponding to at least topology-based semantic map generation may generate the topology edge based at least in part on the topology node with respect to the closed space, at step S740. The method corresponding to at least generating the edge may be referred to the description with reference to FIG. 5.

Finally, the apparatus 100 corresponding to at least topology-based semantic map generation may assign each ID through semantic distinction with respect to the closed spaces and generate the semantic map, at step S750.

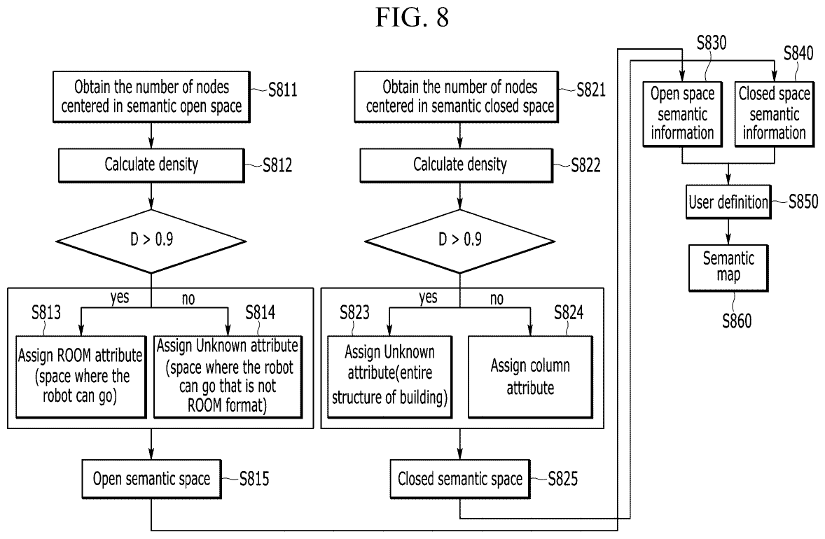

FIG. 8 is a drawing corresponding to at least explaining the spatial meaning assigning step with respect to the semantic space.

In FIG. 8, the apparatus 100 corresponding to at least topology-based semantic map generation may obtain the number of nodes n of an adjacent radius r of 100 pixels by using Kdtree based at least in part on semantic open space center coordinate, at step S811.

In addition, the apparatus 100 corresponding to at least topology-based semantic map generation may obtain the number of nodes n of an adjacent radius r of 50 pixels by using Kdtree based at least in part on semantic closed space center coordinate, at step S821.

The apparatus 100 corresponding to at least topology-based semantic map generation may determine the density based at least in part on the number of nodes obtained with respect to each of the open space and the closed space, at step S812 and step S822.

The apparatus 100 corresponding to at least topology-based semantic map generation may obtain a circular area A based at least in part on the adjacent radius r, and may determine a result obtained by dividing the number of nodes n by the circular area A as a density D.

When the density of the open space is greater than a predetermined threshold value (e.g., 0.9), the apparatus 100 corresponding to at least topology-based semantic map generation may assign a ROOM attribute as a space where the robot can go, at step S813.

When the density of the open space is smaller than or equal to the predetermined threshold value (e.g., 0.9), the apparatus 100 corresponding to at least topology-based semantic map generation may assign an Unknown attribute, at step S814. The Unknow characteristic may be a space where the robot can go other than a ROOM format.

The apparatus 100 corresponding to at least topology-based semantic map generation may define an open semantic space including spaces to which attributes are assigned, at step S815.

When the density of the closed space is greater than the predetermined threshold value (e.g., 0.9), the apparatus 100 corresponding to at least topology-based semantic map generation may assign Unknown attribute to the entire structure of the building, at step S823.

When the density of the closed space is smaller than or equal to the predetermined threshold value (e.g., 0.9), the apparatus 100 corresponding to at least topology-based semantic map generation may assign a column attribute, at step S824. The apparatus 100 corresponding to at least topology-based semantic map generation may define a closed semantic space including spaces to which attributes are assigned, at step S825.

The apparatus 100 corresponding to at least topology-based semantic map generation may combine semantic information of the open semantic space to which an attribute is assigned and semantic information of the closed space to which an attribute is assigned, at step S830 and step S840.

The apparatus 100 corresponding to at least topology-based semantic map generation may provide the open semantic space and the closed semantic space so that the user can define them, at step S850.

The apparatus 100 corresponding to at least topology-based semantic map generation may generate the semantic map including semantic spaces determined according to the user definition, at step S860.

FIG. 9 is a block diagram of an apparatus corresponding to at least topology-based semantic map generation according to an embodiment.

Referring to FIG. 9, the apparatus 100 corresponding to at least topology-based semantic map generation may include a mapping module 110, data pre-processing module 120, the topology node generating module 130, the topology edge generating module 140 and a semantic map generating module 150.

The mapping module 110 may map the environment through the sensor of the robot to generate an initial map.

The mapping module 110 may generate an occupancy grid map (OGM) through LiDAR-based mapping.

The data pre-processing module 120 may generate the topology space through data pre-processing based at least in part on an initial OGM map.

The data pre-processing module 120 may convert the OGM map into a binarized map, and may generate the distance conversion map based at least in part on the binarized map.

The topology node generating module 130 may generate the topology node based at least in part on the topology space.

The topology node generating module 130 may generate the topology space by normalizing the distance conversion map.

The topology node generating module 130 may determine spaces where the robot can go and spaces where the robot cannot go based at least in part on the distance conversion map, may determine the space where the robot can go as the open space, and may determine the space where the robot cannot go as the closed space.

The topology node generating module 130 may determine the closed space based at least in part on the ROI designated as the open space.

The topology node generating module 130 may generate nodes of a topology graph including the open space and the closed space.

For example, the topology node generating module 130 may set the size of the grid pixel by reflecting the size of the robot, and may set the interval between nodes based at least in part on the size of the grid pixel.

The topology edge generating module 140 may generate the topology edge with respect to the topology node.

The topology edge generating module 140 may generate an edge with respect to each of the open space topology graph and the closed space topology graph.

The topology edge generating module 140 may, with respect to each of the open space topology graph and the closed space topology graph, search the distance between nodes based at least in part on the interval between nodes and generate an edge connecting adjacent nodes of which the shortest distance falls within the preset minimum distance.

The semantic map generating module 150 may assign a semantic spatial information with respect to the topology space based at least in part on the topology node and the topology edge, and may generate the semantic map.

The semantic map generating module 150 may generate each of the semantic information of the open space and the semantic information of the closed space.

The semantic map generating module 150 may distinguish the space of the open space based at least in part on the semantic information of the open space.

The semantic map generating module 150 may distinguish the space of the closed space based at least in part on the semantic information of the closed space.

The semantic map generating module 150 may assign meaning to the distinguished space of each of the open space and the closed space, according to the semantic information of the open space user definition.

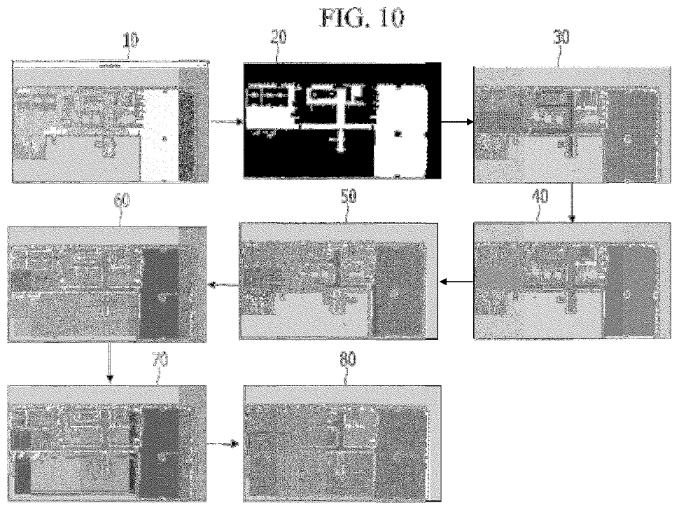

FIG. 10 is an example diagram corresponding to at least explaining topology-based semantic map generation according to an embodiment.

In FIG. 10, when an occupancy grid map 10 is received, the apparatus 100 corresponding to at least topology-based semantic map generation may generate the topology space map 20 through binarization, distance conversion, and normalization.

The apparatus 100 corresponding to at least topology-based semantic map generation may generate a first topology node 30 with respect to the open space in the topology space map 20.

The apparatus 100 corresponding to at least topology-based semantic map generation may generate a first topology edge 40 based at least in part on the first topology node 30.

The apparatus 100 corresponding to at least topology-based semantic map generation may semantically distinguish the open spaces based at least in part on the first topology node 30 and the first topology edge 40 and generate a first semantic map 50.

The apparatus 100 corresponding to at least topology-based semantic map generation may generate a second topology node 60 with respect to the closed space excluding the open space based at least in part on the first semantic map 50.

The apparatus 100 corresponding to at least topology-based semantic map generation may generate a second topology edge 70 based at least in part on the second topology node 60 of the closed space.

The apparatus 100 corresponding to at least topology-based semantic map generation may generate a final semantic map 80 by semantically distinguishing the closed spaces based at least in part on the second topology node 60 and the second topology edge 70 of the closed space.

FIG. 11 is a drawing corresponding to at least explaining a computing device according to an embodiment.

Referring to FIG. 8, an apparatus and method corresponding to at least topology-based semantic map generation according to an embodiment may be implemented by using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 10.

The memory 930 and the storage device 960 may include various types of volatile or non-volatile storage media. For example, the memory may include a read-only memory (ROM) 931 and random-access memory (RAM) 932. In this embodiment, the memory 930 may be located inside or outside processor 910, and the memory 930 may be connected to the processor 910 through various known means.

In some embodiments, at least some configurations or functions of the apparatus and method corresponding to at least topology-based semantic map generation according to an embodiment may be implemented as a program or software executable by the computing device 900, and program or software may be stored in a computer-readable medium.

In some embodiments, at least some configurations or functions of the apparatus and method corresponding to at least topology-based semantic map generation according to an embodiment may be implemented by using hardware or circuitry of the computing device 900, or may also be implemented as separate hardware or circuitry that may be electrically connected to the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of appended claims.

What is claimed is:

1. A method for topology-based semantic map generation, the method comprising:
mapping, by a processor, an environment through a sensor of a robot to generate an initial map;
generating, by the processor, a topology space through data pre-processing based at least in part on the initial map;
generating, by the processor, a topology node based at least in part on the topology space;
generating, by the processor, a topology edge with respect to the topology node;
assigning, by the processor, semantic spatial information with respect to the topology space based at least in part on the topology node and the topology edge; and
generating, by the processor, the semantic map.

2. The method of claim 1, wherein the mapping the environment comprises:
collecting data of the environment through a lidar and an IMU sensor;
estimating a position of the robot based at least in part on the collected data;
generating a 3D map through a 3D point cloud; and
converting the 3D map into a 2D occupancy grid map.

3. The method of claim 2, wherein the generating the topology space comprises:
converting the 2D occupancy grid map into a binarized map by binarization processing;
generating a distance conversion map through distance conversion based at least in part on the binarized map; and
generating the topology space by normalizing the distance conversion map.

4. The method of claim 1, wherein the generating the topology node comprises:
setting a size of a grid pixel by reflecting a size of the robot; and
setting an interval between nodes based at least in part on the size of the grid pixel.

5. The method of claim 1, wherein the generating the topology edge with respect to the topology node comprises:
searching a distance between nodes based at least in part on an interval between nodes; and
generating edges connecting adjacent nodes of which the distance falls within a preset minimum distance.

6. The method of claim 5, wherein the searching the distance between nodes comprises:
searching the distance between nodes by using a KD Tree;
connecting adjacent nodes based at least in part on the minimum distance and the generated edge information;
checking whether there is an obstacle between edges based at least in part on the edge information and then deleting one or more edges where the obstacle exists; and
checking whether the generated edge information overlaps with already stored edge information, and updating the edge information.

7. The method of claim 1, wherein the assigning semantic spatial information comprises:
grouping the topology space by using the topology node and the topology edge;
semantically distinguishing the topology space; and
assigning an ID to the distinguished topology space.

8. The method of claim 7, wherein the grouping the topology space comprises:
initializing, corresponding to at least setting all nodes as an independent group through a Union-Find algorithm; and
determining nodes connected to each other as a same group by using the edge.

9. The method of claim 1, wherein the generating the topology space comprises:
dividing the topology space into an open space where the robot can move and a closed space where the robot cannot move.

10. The method of claim 9, wherein the dividing the topology space comprises:
generating the open space through pre-processing in the initial map; and
defining the open space as a region-of-interest (ROI), and determining a region out of the ROI as the closed space.

11. A robot comprising:
one or more processors; and
a non-transitory computer-readable medium having stored thereon executable instructions which when executed by the one or more processors, cause the one or more processors to perform:
mapping an environment through a sensor of the robot to generate an initial map;
generating a topology space through data pre-processing based at least in part on the initial map;
generating a topology node based at least in part on the topology space;
generating a topology edge with respect to the topology node;
assigning a semantic spatial information with respect to the topology space based at least in part on the topology node and the topology edge; and
generating the semantic map.

12. The robot of claim 11, wherein the instructions for mapping the environment comprise further instructions to perform:
collecting data of the environment through a lidar and an IMU sensor;
estimating a position of the robot based at least in part on the collected data;
generating a 3D map through a 3D point cloud; and
converting the 3D map into a 2D occupancy grid map.

13. The robot of claim 12, wherein the instructions for generating the topology space comprise further instructions to perform:
converting the 2D occupancy grid map into a binarized map by binarization processing;
generating a distance conversion map through distance conversion based at least in part on the binarized map; and
generating the topology space by normalizing the distance conversion map.

14. The robot of claim 11, wherein the instructions for generating the topology node comprise further instructions to perform:
setting a size of a grid pixel by reflecting a size of the robot; and
setting an interval between nodes based at least in part on the size of the grid pixel.

15. The robot of claim 11, wherein the instructions for generating the topology edge comprise further instructions to perform:
searching a distance between nodes based at least in part on an interval between nodes and generating edges connecting adjacent nodes of which the distance falls within a preset minimum distance.

16. The robot of claim 15, wherein the instructions for searching the distance between nodes comprise further instructions to perform:
searching the distance between nodes by using a KD Tree;
connecting adjacent nodes based at least in part on the minimum distance and generated edge information;
checking whether there is an obstacle between edges based at least in part on the edge information and then deleting one or more edges where the obstacle exists; and
checking whether the generated edge information overlaps with already stored edge information and updating the edge information.

17. The robot of claim 11, wherein the instructions for assigning the semantic spatial information comprise further instructions to perform:
grouping the topology space by using the topology node and the topology edge;
semantically distinguishing the topology space; and
assigning an ID to the distinguished topology space.

18. The robot of claim 17, wherein the instructions for grouping the topology space comprise further instructions to perform:
initializing, corresponding to at least setting all nodes as an independent group through a Union-Find algorithm; and
determining nodes connected to each other as a same group by using the edge.

19. The robot of claim 11, wherein the instructions for generating the topology space comprise further instructions to perform:
dividing the topology space into an open space where the robot can move and a closed space where the robot cannot move.

20. The robot of claim 19, wherein the instructions for dividing the topology space comprise further instructions to perform:
generating the open space through pre-processing in the initial map; and
defining the open space as a region-of-interest (ROI), and determining a region out of the ROI as the closed space.
